(19) United States
(12) Patent Application Publication
(10) Pub. No.: US 2022/0203314 A1
(43) Pub. Date: Jun. 30, 2022

(54) EXHAUST GAS DIFFUSING DEVICE

(71) Applicant: KUBOTA CORPORATION, Osaka (JP)

(72) Inventors: Haruki MITSUI, Sakai-shi (JP); Tadashi NAKAMURA, Sakai-shi (JP)

(21) Appl. No.: 17/540,273

(22) Filed: Dec. 2, 2021

(30) Foreign Application Priority Data
Dec. 25, 2020 (JP) 2020-216956

(51) Int. Cl. B01F 25/431; B01F 23/10

(52) U.S. Cl. CPC B01F 25/4316; B01F 23/19

(57) ABSTRACT

An exhaust gas diffusing device includes an outside air mixing cylinder with an inner diameter larger than an outer diameter of a discharge-side end portion of an exhaust pipe to send out exhaust gas of an engine of a vehicle, the outside air mixing cylinder positioned to receive the exhaust gas from the exhaust pipe and to receive outside air to be mixed with the exhaust gas, and at least one air director at a position on the outside air mixing cylinder upstream in a direction in which the exhaust gas flows or in the exhaust pipe to promote the mixing.

### CROSS REFERENCE TO RELATED APPLICATIONS

This application is based on and claims priority under 35 U.S.C. Section 119 to Japanese Patent Application No. 2020-216956 filed on Dec. 25, 2020, the entire contents of which are incorporated herein by reference.

### BACKGROUND OF THE INVENTION

### 1. Field of the Invention

The present invention relates to exhaust gas diffusing devices.

### 2. Description of the Related Art

JP 552-152911U1 and JP 554-108817U1 each disclose an exhaust gas diffusing device including, at an end portion of an exhaust pipe, a cylindrical member for diffusing exhaust gas.

JP 552-152911U1 discloses a unit (“muffler cutter”) including an attachment pipe and a mixing/discharging pipe attached to the attachment pipe. The mixing/discharging pipe has a diameter larger than that of the exhaust pipe. The mixing/discharging pipe has, at an end portion thereof on the exhaust pipe side, a plurality of introduction openings for introducing outside air. The mixing/discharging pipe contains a freely rotatable fan.

Attaching the attachment pipe to the back end of the exhaust pipe results in the mixing/discharging pipe overlapping with the back end of the exhaust pipe. The mixing/discharging pipe receives exhaust gas as well as outside air, diffuses the exhaust gas by means of rotation of the fan at an intermediate portion of the mixing/discharging pipe to reduce the concentration of the exhaust gas, and then discharges the exhaust gas.

JP S54-108817U1 discloses a unit (“diffuser”) including a cylinder having an elliptical cross section and an exhaust pipe connection fitting attached to an end portion of the cylinder. The cylinder has first outside air introduction openings, and contains a pair of guide vanes facing each other.

The pair of guide vanes define a nozzle therebetween. The cylinder has second outside air introduction openings in the vicinity of the nozzle. Connecting the exhaust pipe connection fitting to the exhaust pipe allows exhaust gas from the exhaust pipe to be introduced into the cylinder. The exhaust gas thus introduced increases its flow speed at the nozzle. The cylinder introduces outside air through the second outside air introduction openings as well as the first outside air introduction openings to cool the exhaust gas before discharging it.

### SUMMARY OF THE INVENTION

A work vehicle such as a tractor including a diesel engine, for example, may include a diesel particulate filter (DPF) to clean exhaust gas. However, including a DPF raises a concern that exhaust gas discharged from the engine may be heated up as a result of heat generation through the cleaning process and may be discharged without being cooled sufficiently.

Such high-temperature exhaust gas may be cooled with the use of, for example, the diffusion technique disclosed in JP S52-152911U1 or JP S54-108817U1. The technique of JP S52-152911U1, however, mixes exhaust gas with outside air at an intermediate portion of the mixing/discharging pipe before discharging the exhaust gas. The mixing/discharging pipe is long as a result. The technique of JP S54-108817U1 uses a pair of guide vanes to define a throttle nozzle. The pair of guide vanes thus partially block the flow of exhaust gas.

The above circumstances have led to a demand for an exhaust gas diffusing device that cools exhaust gas from an exhaust pipe, that does not block the flow of exhaust gas, and that does not require an increased distance for exhaust gas and outside air to be mixed with each other.

An exhaust gas diffusing device according to a preferred embodiment of the present invention includes an outside air mixing cylinder with an inner diameter larger than an outer diameter of a discharge-side end portion of an exhaust pipe to send out exhaust gas of an engine of a vehicle, the outside air mixing cylinder positioned to receive the exhaust gas from the exhaust pipe and to receive outside air to be mixed with the exhaust gas, and at least one air director disposed (i) at a position on the outside air mixing cylinder upstream in a direction in which the exhaust gas flows, or (ii) in the exhaust pipe, to promote the mixing of the exhaust gas with the outside air.

The above configuration allows exhaust gas from the exhaust pipe to enter the outside air mixing cylinder together with outside air, and causes the exhaust gas and the outside air to flow as guided by the air director. This promotes mixing of exhaust gas with outside air. Further, the air director is disposed either in the exhaust pipe or at a position on the outside air mixing cylinder upstream in the direction in which exhaust gas flows. This makes it possible to not only mix exhaust gas with outside air but also dissipate heat without the need to increase the distance over which exhaust gas and outside air flow through the space inside the outside air mixing cylinder from its upstream portion to its downstream portion.

The above configuration thus provides an exhaust gas diffusing device that cools exhaust gas from an exhaust pipe, that does not block the flow of exhaust gas, and that does not require an increased distance for exhaust gas and outside air to be mixed with each other.

The at least one air director may be disposed only in the exhaust pipe.

With the above configuration, the air director is disposed in the exhaust pipe only. This simple configuration allows exhaust gas to be guided into the outside air mixing cylinder.

The at least one air director may be disposed at the discharge-side end portion of the exhaust pipe.

With the above configuration, the air director is disposed at the discharge-side end portion of the exhaust pipe. This allows exhaust gas flowing in a direction defined by the air director to directly enter the outside air mixing cylinder past the air director.

The exhaust gas diffusing device may include a gap between the discharge-side end portion and an end portion of the outside air mixing cylinder which end portion is upstream in the direction in which the exhaust gas flows.

The above configuration causes a negative pressure when exhaust gas flows from the exhaust pipe into the outside air mixing cylinder. The negative pressure in turn draws in outside air through the gap into the outside air mixing cylinder.

The at least one air director may not be positioned coincide with the outside air mixing cylinder as viewed in a direction orthogonal to the direction in which the exhaust gas flows.

The above configuration involves a gap between the air director on the exhaust pipe and the outside air mixing cylinder which gap allows outside air to pass therethrough. The air director thus does not prevent outside air from being drawn in.

The at least one air director may be oriented to guide the exhaust gas in such a direction that the exhaust gas comes into contact with an inner surface of the outside air mixing cylinder.

With the above configuration, the air director guides exhaust gas toward the inner surface of the outside air mixing cylinder. This allows exhaust gas to come into contact with the inner surface of the outside air mixing cylinder for efficient heat dissipation. In particular, guiding exhaust gas toward the inner surface of the outside air mixing cylinder causes the exhaust gas to whirl along the inner surface, thus promoting the mixing of exhaust gas with outside air.

The at least one air director may include a plurality of air directors arranged in point symmetry to each other as viewed in the direction in which the exhaust gas flows.

With the above configuration, the plurality of air directors guide exhaust gas uniformly or substantially uniformly and cause the exhaust gas to whirl, thus efficiently mixing exhaust gas with outside air.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a side view of a tractor including an exhaust gas diffusing device.

FIG. 2 is an exploded perspective view of an exhaust pipe, an intermediate cylinder, and air directors.

FIG. 3 is a perspective view of an exhaust pipe, air directors attached thereto, and an outside air mixing cylinder.

FIG. 4 is a side view of an exhaust pipe, air directors attached thereto, and an outside air mixing cylinder.

FIG. 5 is a cross-sectional view taken along line V-V in FIG. 4.

FIG. 6 is a perspective view of an exhaust pipe and an outside air mixing cylinder according to alternative preferred embodiment (a) of the present invention.

FIG. 7 is a cross-sectional view taken along line VII-VII in FIG. 6.

FIG. 8 is a perspective view of an exhaust pipe and an outside air mixing cylinder according to alternative preferred embodiment (b) of the present invention.

FIG. 9 is a cross-sectional view taken along line IX-IX in FIG. 8.

FIG. 10 is a perspective view of an exhaust pipe and an outside air mixing cylinder according to alternative preferred embodiment (c) of the present invention.

FIG. 11 is a cross-sectional view of an exhaust pipe and an outside air mixing cylinder according to alternative preferred embodiment (d) of the present invention.

### DETAILED DESCRIPTION OF THE PREFERRED EMBODIMENTS

The description below describes preferred embodiments of the present invention with reference to drawings.

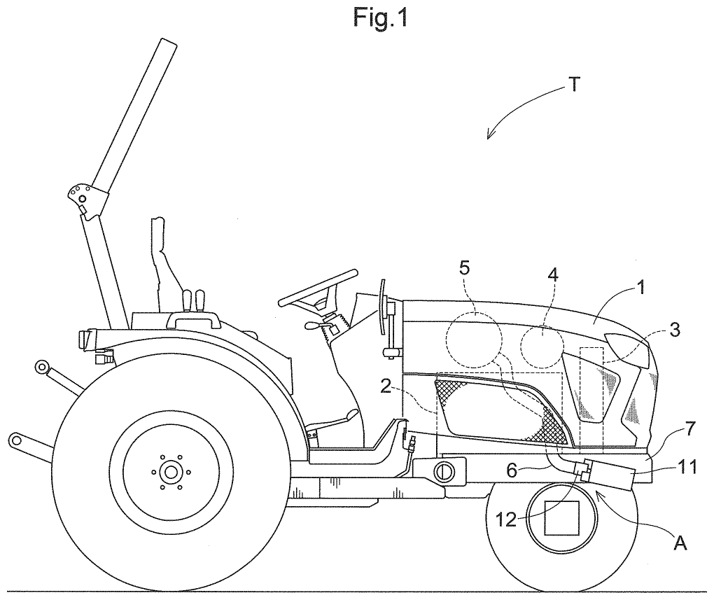

FIG. 1 illustrates a tractor T as a work vehicle. The tractor T includes a hood 1 at a front portion thereof, and also includes inside the hood 1 a diesel engine 2, a radiator 3, an air cleaner 4, and a diesel particulate filter (DPF) cleaning device 5 to clean exhaust gas.

The tractor T also includes an exhaust pipe 6, a body frame 7, and an exhaust gas diffusing device A. The exhaust gas diffusing device A includes an outside air mixing cylinder 11 at a position on a side of the body frame 7 so as to receive exhaust gas from the exhaust pipe 6. The exhaust gas diffusing device A allows exhaust gas of the engine 2 cleaned by the cleaning device 5 and thus heated to be mixed with outside air to be cooled.

The exhaust pipe 6 is positioned at a front portion of the vehicle body and oriented so as to discharge exhaust gas in an obliquely downward direction. The outside air mixing cylinder 11 is oriented so as to send out exhaust gas in the direction of the exhaust pipe 6.

As illustrated in FIGS. 1 to 5, the exhaust gas diffusing device A includes an outside air mixing cylinder 11, an intermediate cylinder 12, and air directors 13 supported by the intermediate cylinder 12. The outside air mixing cylinder 11, the intermediate cylinder 12, and the air directors 13 are each made of, for example, a heat-resistant steel material or a stainless steel material.

The exhaust pipe 6 has a cylindrical axis X virtually extending through the center of the pipe. The outside air mixing cylinder 11 has its center extending coaxially with the cylindrical axis X. The intermediate cylinder 12 is fitted around the exhaust pipe 6 and fixed thereto by a plurality of bolts 15. The intermediate cylinder 12 is provided with a pair of support frames 14 fixed thereto. The air directors 13 are integral with one of the support frames 14 (detailed later).

With the above configuration, the air directors 13 are at a discharge-side end portion 6E of the exhaust pipe 6. The air directors 13 are, in other words, provided for the exhaust pipe 6 only.

As illustrated in FIG. 5, the outside air mixing cylinder 11 is a cylinder with an inner diameter D2 larger than the outer diameter D1 of the discharge-side end portion 6E of the exhaust pipe 6. The outside air mixing cylinder is held in place by the body frame 7 of the tractor T. The intermediate cylinder 12 is fitted around and fixed to the discharge-side end portion 6E of the exhaust pipe 6, and holds the air directors 13 in place.

The outside air mixing cylinder 11 may alternatively be held in place by (i) the exhaust pipe 6 with, for example, a bracket in-between or (ii) the intermediate cylinder 12 fitted around and fixed to the exhaust pipe 6.

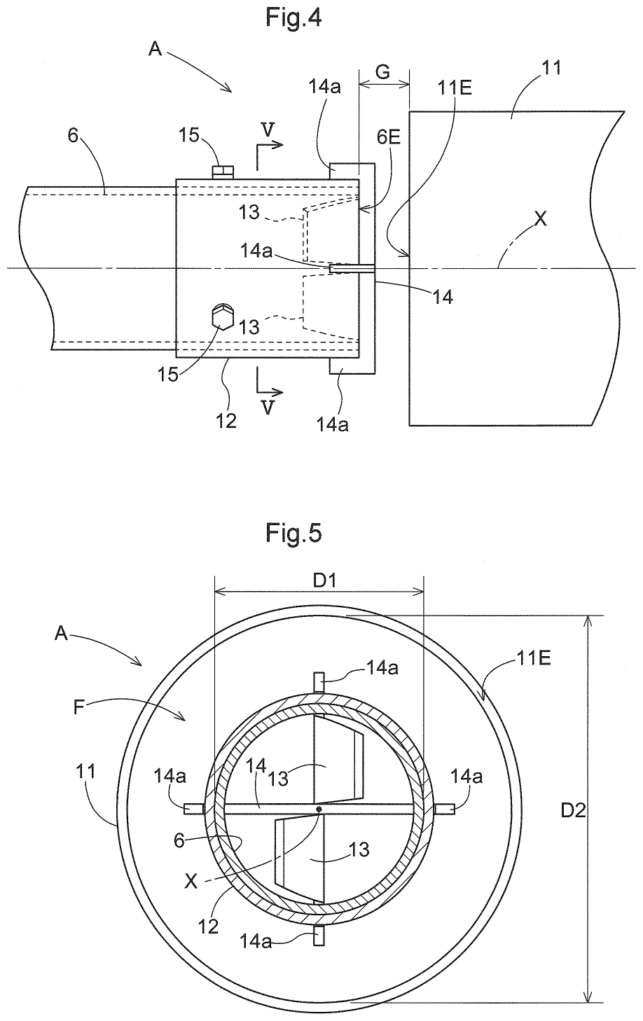

As illustrated in FIG. 4, placing the exhaust pipe 6 and the outside air mixing cylinder 11 in position results in a gap G being defined between the discharge-side end portion 6E of the exhaust pipe 6 and the upstream end portion 11E of the outside air mixing cylinder 11. The present preferred embodiment is arranged such that the air directors 13 are in a space inside the discharge-side end portion 6E of the exhaust pipe 6 and such that the air directors 13 and the outside air mixing cylinder 11 are positioned so as not to coincide with each other as viewed in the direction orthogonal to the direction in which exhaust gas flows (that is, in the direction in which FIG. 4 is viewed).

FIG. 4 illustrates a case of the discharge-side end portion 6E and the corresponding end portion of the intermediate cylinder 12 coinciding with each other. In a case where, for instance, the intermediate cylinder 12 protrudes from the discharge-side end portion 6E of the exhaust pipe 6, the gap G is defined between the end portion of the intermediate cylinder 12 and the upstream end portion 11E of the outside air mixing cylinder 11.

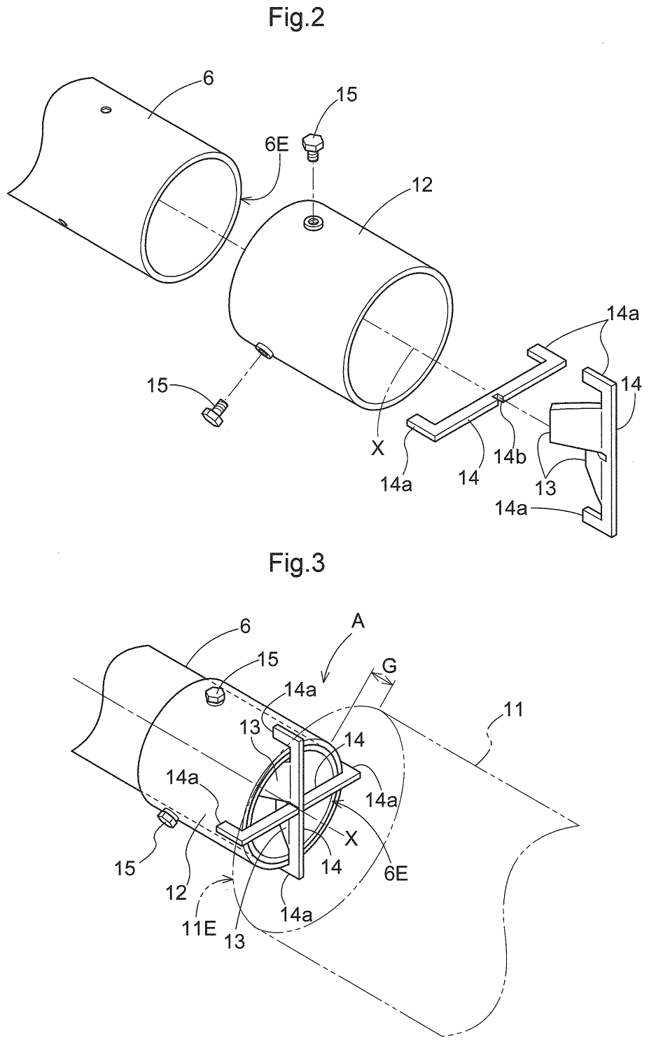

As illustrated in FIGS. 2 to 5, the two air directors 13 are, for example, press-worked to be integral with a first one of the pair of support frames 14, and are inclined in respective directions opposite to each other. The two air directors 13 are, as illustrated in FIG. 5, in point symmetry to each other as viewed in the direction in which exhaust gas flows from the exhaust pipe 6 (that is, in the direction of the cylindrical axis X).

As illustrated in FIG. 2, a second one of the pair of support frames 14 includes a depression 14b at a central position in its length direction (that is, in the radial direction of the intermediate cylinder 12). Engaging the first support frame 14 with the depression 14b and welding the first support frame 14 to the second support frame 14 for fixation results in the pair of support frames 14 being orthogonal to each other and radially crossing the intermediate cylinder 12 as viewed in the direction of the cylindrical axis X.

The support frames 14 each include, at respective opposite ends thereof, engagement sections 14a each including a bend in the direction of the cylindrical axis X. The support frames 14 are welded and fixed to the outer surface of the intermediate cylinder 12 with the engagement sections 14a in contact with an outer edge of the intermediate cylinder 12.

The above configuration involves a gap between the radially outer end of each of the pair of air directors 13 on the first support frame 14 and the inner surface of the intermediate cylinder 12. The gap receives the discharge-side end portion 6E of the exhaust pipe 6 when the intermediate cylinder 12 is fitted around the exhaust pipe 6. This allows the air directors 13 to be inside the exhaust pipe 6 as viewed in the direction orthogonal to the direction in which exhaust gas flows (that is, in the direction orthogonal to the cylindrical axis X).

The above configuration causes exhaust gas from the exhaust pipe 6 to come into contact with the pair of air directors 13 immediately before being discharged from the discharge-side end portion 6E of the exhaust pipe 6 and then be sent out toward the inner surface of the outside air mixing cylinder 11 as illustrated in FIG. 4. Orienting the pair of air directors 13 in a particular manner causes exhaust gas to, after coming into contact with the air directors 13, be sent out toward the inner surface of the outside air mixing cylinder 11 such that the exhaust gas whirls along the inner surface of the outside air mixing cylinder 11 (that is, about the cylindrical axis X as the center). The air directors 13 configured as above do not block the flow of exhaust gas, and allow exhaust gas to flow with a reduced pressure loss.

As described above, the gap G is between the exhaust pipe 6 and the outside air mixing cylinder 11. The gap G causes a negative pressure when exhaust gas flowing along the cylindrical axis X passes through the gap G. The negative pressure in turn causes outside air to enter the outside air mixing cylinder 11 through an outside air introducing section F. The air directors 13, which guide exhaust gas toward the inner surface of the outside air mixing cylinder 11, promote mixing of exhaust gas with outside air introduced through the outside air introducing section F.

The above configuration allows exhaust gas to be diffused to promote mixing of exhaust gas with outside air without requiring an increased distance for exhaust gas and outside air to be mixed with each other inside the outside air mixing cylinder 11. This makes it possible to reduce the length of the outside air mixing cylinder 11 (that is, the dimension thereof along the cylindrical axis X) and discharge cooled exhaust gas from the discharge-side end portion. The above configuration, which does not require the outside air mixing cylinder 11 to be long, does not require the exhaust gas diffusing device A to be large-sized.

The outside air mixing cylinder 11 has an outer surface in constant contact with outside air. Further, exhaust gas mixed with outside air as described above flows through the outside air mixing cylinder 11 while in contact with its inner surface so as to whirl along the inner surface. This further promotes heat dissipation, thus allowing suitable heat dissipation.

### ALTERNATIVE PREFERRED EMBODIMENTS

The present invention may alternatively be configured or structured as below other than the preferred embodiment described above. Any member below that is identical in function to a particular member described for the above preferred embodiment has the same reference sign as that particular member.

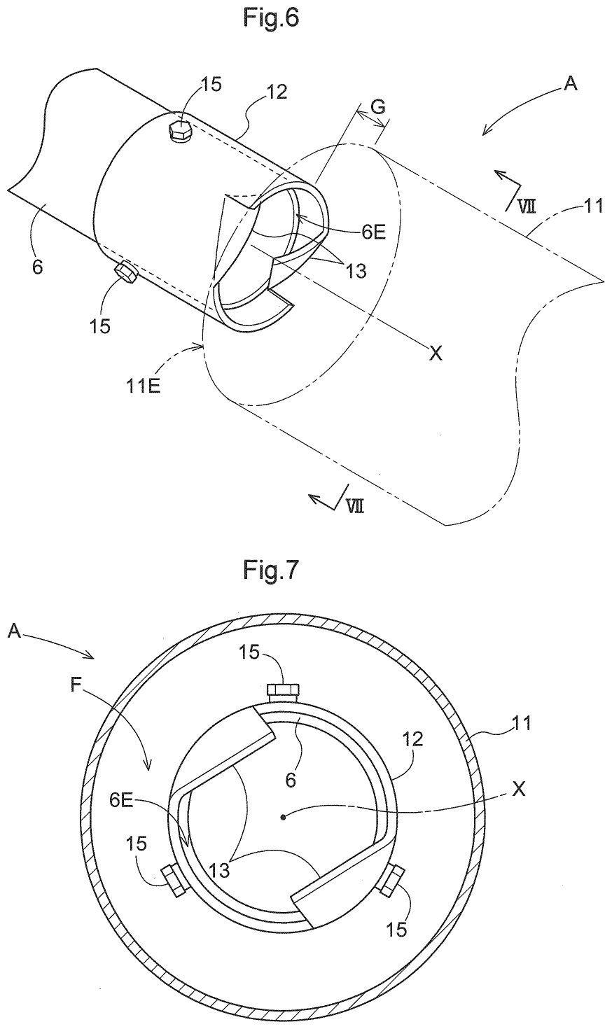

(a) The present invention may be modified as illustrated in FIGS. 6 and 7 by (i) cutting, in an end portion of the intermediate cylinder 12, a pair of slits parallel to the cylindrical axis X, (ii) bending, toward the center of the intermediate cylinder 12, portions of the intermediate cylinder 12 that are in the vicinity of the slits such that those portions are inclined to guide exhaust gas (that is, to define and function as air directors 13), and (iii) fitting the intermediate cylinder 12 around the exhaust pipe 6 to fix the intermediate cylinder 12 thereto.

This alternative preferred embodiment (a) involves simply cutting slits in an end portion of the intermediate cylinder 12 and bending portions thereof to define air directors 13. This eliminates the need to additionally include dedicated air directors 13, and reduces the number of necessary parts. Alternative preferred embodiment (a), similarly to the preferred embodiment described above, causes exhaust gas to whirl along the inner surface of the outside air mixing cylinder 11 while in contact therewith for suitable heat dissipation.

Alternatively, preferred embodiment (a) may be varied by, for instance, cutting slits in the back end of the exhaust pipe 6 and bending portions thereof to define air directors 13.

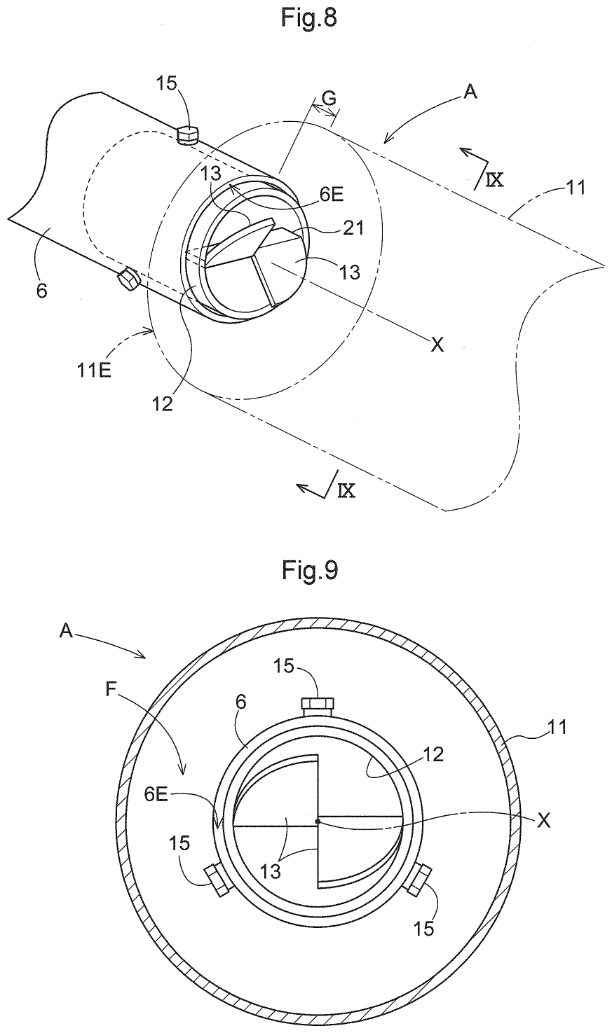

(b) The present invention may be modified as illustrated in FIGS. 8 and 9 by (i) preparing a plate-shaped member 21 including bent end portions as a pair of air directors 13, (ii) inserting the plate-shaped member 21 into the intermediate cylinder 12 such that the plate-shaped member 21 is oriented radially, (iii) welding or otherwise fixing the plate-shaped member 21 to the intermediate cylinder 12, and (iv) inserting the intermediate cylinder into the discharge-side end portion 6E of the exhaust pipe 6 to fix the intermediate cylinder 12 thereto.

This alternative preferred embodiment (b), which includes a plate-shaped member 21 fixed inside the intermediate cylinder 12, allows air directors 13 to be formed easily. Alternative preferred embodiment (b), similarly to the preferred embodiment described above, causes exhaust gas to whirl along the inner surface of the outside air mixing cylinder 11 while in contact therewith for suitable heat dissipation.

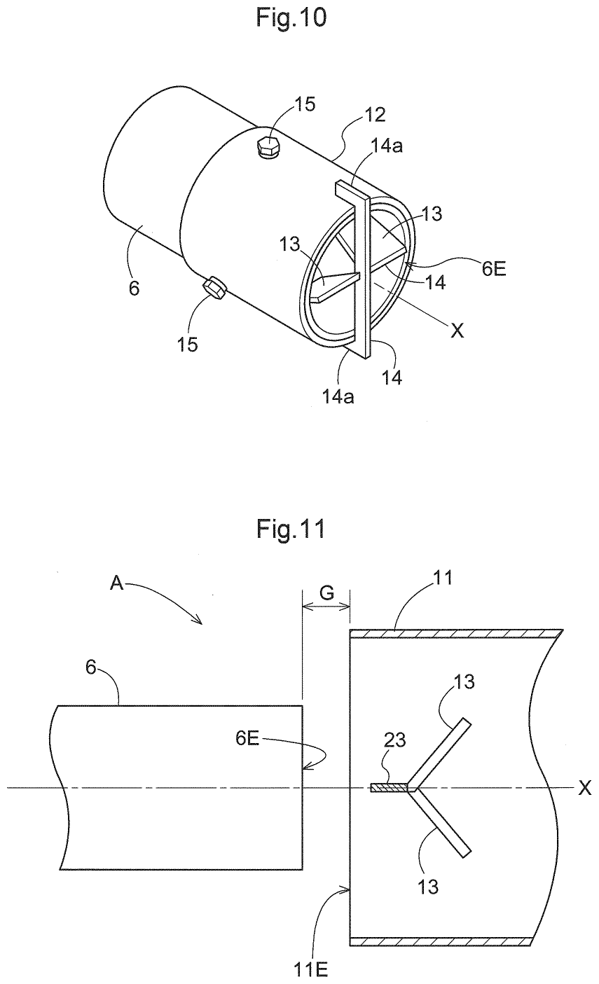

(c) The present invention may be modified as illustrated in FIG. 10 such that only one of the pair of support frames 14 for the preferred embodiment described above includes engagement sections 14a and that air directors 13 are provided on the other support frame 14. The pair of support frames 14 for this preferred embodiment are welded and fixed to each other at a portion at which the pair of support frames 14 cross each other.

This alternative preferred embodiment (c) allows size reduction of the support frame 14 on which the air directors 13 are provided.

(d) The present invention may be modified as illustrated in FIG. 11 by including air directors 13 at a position inside the outside air mixing cylinder 11 which position is upstream in the direction in which exhaust gas flows. The pair of air directors 13 for this preferred embodiment are provided on an internal plate 23 welded or otherwise fixed inside the outside air mixing cylinder 11. The pair of air directors 13 coincide, as viewed in the direction of the cylindrical axis X, with the path into which exhaust gas is sent out from the exhaust pipe 6.

This alternative preferred embodiment (d), similarly to the preferred embodiment described above, causes exhaust gas to whirl along the inner surface of the outside air mixing cylinder 11 while in contact therewith for suitable heat dissipation.

(e) The number of air directors 13 is not limited to two, but may be three or more. Further, the air directors 13 may be provided both for the exhaust pipe 6 and inside the outside air mixing cylinder 11.

(f) The exhaust gas diffusing device A does not necessarily have a gap G between the discharge-side end portion 6E of the exhaust pipe 6 and the outside air mixing cylinder 11. The discharge-side end portion 6E of the exhaust pipe 6 and the outside air mixing cylinder 11 may, for instance, slightly overlap with each other as viewed in the direction orthogonal to the cylindrical axis X.

(g) The air directors 13 do not necessarily protrude from the discharge-side end portion 6E of the exhaust pipe 6. This configuration of the air directors 13 not protruding from the discharge-side end portion 6E of the exhaust pipe 6 may be combined with the configuration of the exhaust gas diffusing device A having no gap G between the discharge-side end portion 6E of the exhaust pipe 6 and the outside air mixing cylinder 11.

Preferred embodiments of the present invention and modifications thereof are applicable to exhaust gas diffusing devices.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An exhaust gas diffusing device, comprising:
an outside air mixing cylinder with an inner diameter larger than an outer diameter of a discharge-side end portion of an exhaust pipe to send out exhaust gas of an engine of a vehicle, the outside air mixing cylinder positioned to receive the exhaust gas from the exhaust pipe and to receive outside air to be mixed with the exhaust gas; and
at least one air director disposed (i) at a position on the outside air mixing cylinder upstream in a direction in which the exhaust gas flows, or (ii) in the exhaust pipe, to promote the mixing of the exhaust gas with the outside air.

2. The exhaust gas diffusing device according to claim 1, wherein the at least one air director is disposed only in the exhaust pipe.

3. The exhaust gas diffusing device according to claim 2, wherein the at least one air director is disposed at the discharge-side end portion of the exhaust pipe.

4. The exhaust gas diffusing device according to claim 2, wherein a gap is between the discharge-side end portion and an end portion of the outside air mixing cylinder upstream in the direction in which the exhaust gas flows.

5. The exhaust gas diffusing device according to claim 2, wherein the at least one air director does not coincide with the outside air mixing cylinder as viewed in a direction orthogonal to the direction in which the exhaust gas flows.

6. The exhaust gas diffusing device according to claim 1, wherein the at least one air director is oriented to guide the exhaust gas in such a direction that the exhaust gas comes into contact with an inner surface of the outside air mixing cylinder.

7. The exhaust gas diffusing device according to claim 1, wherein the at least one air director includes a plurality of air directors arranged in point symmetry to each other as viewed in the direction in which the exhaust gas flows.
